(19) United States
(12) Patent Application Publication
(10) Pub. No.: US 2021/0393382 A1
(43) Pub. Date: Dec. 23, 2021

(54) ASSISTIVE DENTAL SUCTION DEVICE AND METHODS OF USING SAME

(71) Applicant: SipClip, L.L.C., Greensboro, NC (US)

(72) Inventors: Ashley Myers, Greensboro, NC (US); Anish Karpurapu, Vienna, VA (US); Meena Gudapati, Saratoga, CA (US); Frank Marinello, Merrick, NY (US); Yoo Bin Shin, Seoul (KR)

(21) Appl. No.: 17/354,363

(22) Filed: Jun. 22, 2021

Related U.S. Application Data
(60) Provisional application No. 63/042,042, filed on Jun. 22, 2020.

(51) Int. Cl. A61C 17/08; A61C 17/06; A61C 17/22

(52) U.S. Cl. CPC A61C 17/08; A61C 17/22; A61C 17/096

(57) ABSTRACT

Various implementations include a dental suction device configured to be disposed on a toothbrush having at least one bristle head. The dental suction device includes a main conduit, at least one pair of secondary conduits, and a shaft. The main conduit includes a first end and a second end spaced apart from the first end. Each of the secondary conduits includes a first end and a second end spaced apart from the first end. The first end of each of the secondary conduits is connected in fluid communication with the main conduit. The shaft is coupled to and disposed between the pair of secondary conduits. The shaft is shaped to receive and retain a portion of the toothbrush in between the pair of secondary conduits such that the pair of secondary conduits is configured to apply suction at least subjacent the bristle head.

### BACKGROUND

For many, toothbrushing is a simple, everyday task, but for those with bulbar dysfunction, this seemingly simple task can become a burden. Amyotrophic lateral sclerosis (ALS), a disease characterized by the progressive degeneration of the motor neurons, affects over 450,000 people worldwide. As ALS progresses, the brain loses the ability to control muscle movement and many people can lose the ability to speak, eat, move, and breathe. Some people with ALS can lose function of the muscles in the bulbar area around the mouth and throat, which creates the risk of choking on saliva or other liquids. Due to this increased risk, some resort to ineffective toothbrushing methods or stop brushing their teeth altogether. This is problematic as it can lead to poor oral hygiene which increases the risk of aspirating foreign material into the lungs. As a result, the risk of respiratory infections, a leading cause of death for people with ALS, is increased.

### SUMMARY

Various implementations include a dental suction device configured to be disposed on a toothbrush that has at least one bristle head. The dental suction device includes a main conduit, at least one pair of secondary conduits, and a shaft. The dental suction device includes a main conduit, at least one pair of secondary conduits, and a shaft. The main conduit includes a first end and a second end spaced apart from the first end. Each of the secondary conduits includes a first end and a second end spaced apart from the first end. The first end of each of the secondary conduits is connected in fluid communication with the main conduit. The shaft is coupled to and disposed between the pair of secondary conduits. The shaft is shaped to receive and retain a portion of the toothbrush in between the pair of secondary conduits such that the pair of secondary conduits is configured to apply suction at least subjacent the bristle head.

In some implementations, the second end of the main conduit is in fixedly coupled to the first end of each of the secondary conduits.

In some implementations, the bristle head faces a first direction and the pair of secondary conduits is configured to be disposed on the toothbrush such that the second ends of each of the secondary conduits also face the first direction.

In some implementations, each of the secondary conduits are evenly spaced around the shaft.

In some implementations, each of the secondary conduits includes a first curved portion adjacent the first end of each of the secondary conduits, and each of the secondary conduits further includes a second curved portion adjacent the second end of each of the secondary conduits.

In some implementations, each of the secondary conduits further includes an elongated straight portion between the first curved portion and the second curved portion. In some implementations, the elongated straight portion has a first length, the main conduit has a second length, and the first length is greater than the second length.

In some implementations, the second end of each of the secondary conduits is rounded and smooth, and the second end of each of the secondary conduits is sized and configured to be disposed within the first user's mouth.

In some implementations, the pair of secondary conduits includes a first conduit and a second conduit spaced apart from the first conduit.

In some implementations, the main conduit further includes an outer surface, the outer surface of the main conduit defines a plurality of grooves, and the plurality of grooves is sized and configured to engage with a plurality of ridges defined within a suction tube.

In some implementations, the first end of the main conduit end is tapered.

In some implementations, the device further includes a suction tube removably coupled to the first end of the main conduit end.

In some implementations, the pair of secondary conduits and the shaft include a biocompatible material.

In some implementations, the main conduit includes a first flow path extending from the first end of the main conduit to the second end of the main conduit, and each of the secondary conduits is shaped and configured such that the first flow path is evenly divided between the pair of secondary conduits.

In some implementations, the shaft defines a semi cylindrical channel sized and configured to receive a portion of a toothbrush.

Various implementations include a dental suction system. The dental suction system includes a dental suction device as described above, and a suction hose removably couplable to the first end of the main conduit. The suction hose is configured to provide suction to the main conduit and pair of secondary conduits such that the secondary conduits suction liquids disposed within the mouth of a user.

In some implementations, the system further includes an aspirating/vacuum device coupled to the suction hose and configured to provide suction to the suction hose, main conduit, and pair of secondary conduits.

In some implementations, each of the second ends of the pair of secondary conduits face a first direction. In some implementations, the system further includes a toothbrush having at least one bristle head, the toothbrush being disposed within the shaft such that the bristle head faces the first direction.

Various implementations include a method for suctioning liquids from the mouth of a user. The method includes providing a toothbrush comprising bristles and a toothbrush body; providing a dental suction device as described above; and disposing the pair of secondary conduits and the shaft of the suction device on the toothbrush body such that the pair of secondary conduits are disposed subjacent the bristlehead of the toothbrush.

In some implementations, the method further includes providing a suction hose; coupling the suction hose to the first end of the main conduit of the suction device; providing an aspirating/vacuum device, coupling the vacuum device to the suction hose; and turning on the aspirating/vacuum device such that the aspirating/vacuum device creates suction within the suction hose, main conduit, and pair of secondary conduits.

In some implementations, the method further includes brushing the teeth of the user while the aspirating/vacuum device in on such that the liquid within the mouth of the user is suctioned through the second ends of the pair of secondary conduits.

In some implementations, the dental suction device includes two suction conduits that both include a curved integral hook-like extension.

In some implementations, the two suction conduits include a diameter of about 5 mm to about 7 mm. In some implementations, the two suction conduits include a diameter of about 6.2 mm.

In some implementations, the two suction conduits include a length of about 30 mm to about 50 mm.

In some implementations, the length of the two suction conduits is about 43.6 mm.

In some implementations, the first end of the main suction conduit includes a diameter of about 6 mm to about 8 mm. In some implementations, the diameter of the first end of the main suction conduit is about 7.5 mm.

### BRIEF DESCRIPTION OF DRAWINGS

Example features and implementations are disclosed in the accompanying drawings. However, the present disclosure is not limited to the precise arrangements and instrumentalities shown.

FIG. 1 is a perspective view of an exemplary suction device disposed on a toothbrush.

FIG. 2 is a perspective view of the suction device of FIG. 1.

FIG. 3 is a front view of the suction device of FIG. 1.

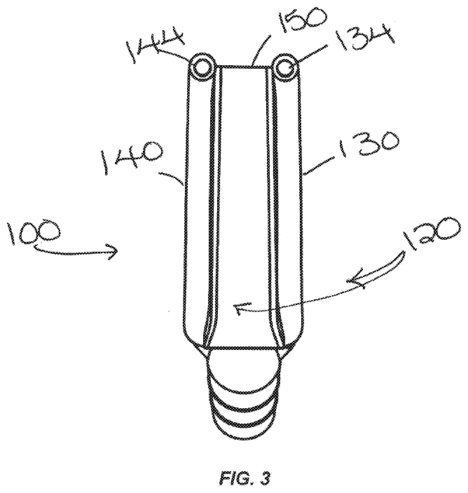

FIG. 4 is a side view of the suction device of FIG. 1.

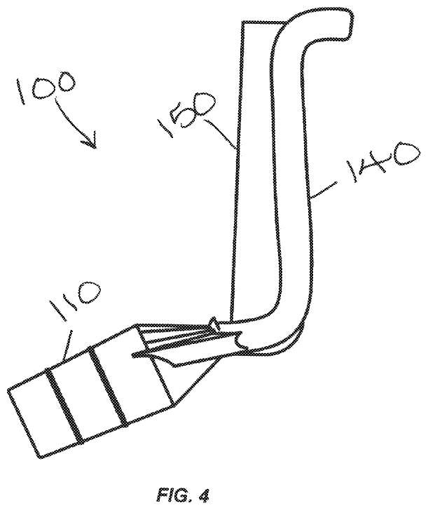

FIG. 5 is a top view of the suction device of FIG. 1.

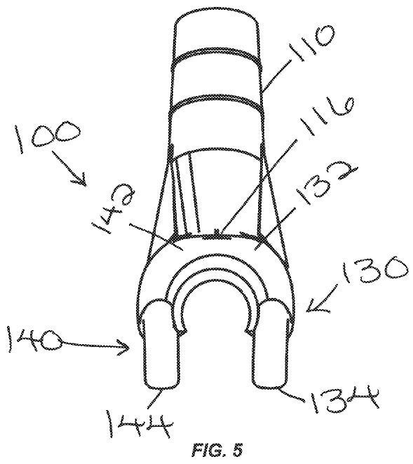

FIG. 6 is a perspective view of a system including the suction device of FIG. 1.

### DETAILED DESCRIPTION

The devices, systems, and methods disclosed herein provide for a dental suction device configured to be disposed on a toothbrush. The dental suction device is removably couplable to any electric and/or manual toothbrush and allows a user to brush their teeth and suction liquid simultaneously. In some implementations, the suction attachment provided herein comprises a universal suction attachment for electric toothbrushes to improve the oral hygiene of people with bulbar dysfunction due to ALS and other neurological conditions. Attaching the suction device to a toothbrush replaces current methods of brushing teeth, which include using a cloth to swab teeth, a dental suction tip to aspirate waste, or not brushing teeth at all. The suction device provided herein makes brushing one's teeth a more accessible and independent task for those with ALS and other neurological conditions, thus increasing oral hygiene and decreasing the risk of choking and respiratory infections.

Various implementations include a dental suction device configured to be disposed on a toothbrush that has at least one bristle head. The dental suction device includes a main conduit, at least one pair of secondary conduits, and a shaft. The dental suction device includes a main conduit, at least one pair of secondary conduits, and a shaft. The main conduit includes a first end and a second end spaced apart from the first end. Each of the secondary conduits includes a first end and a second end spaced apart from the first end. The first end of each of the secondary conduits is connected in fluid communication with the main conduit. The shaft is coupled to and disposed between the pair of secondary conduits. The shaft is shaped to receive and retain a portion of the toothbrush in between the pair of secondary conduits such that the pair of secondary conduits is configured to apply suction at least subjacent the bristle head.

Various implementations include a dental suction system. The dental suction system includes a dental suction device as described above, and a suction hose removably couplable to the first end of the main conduit. The suction hose is configured to provide suction to the main conduit and pair of secondary conduits such that the secondary conduits suction liquids disposed within the mouth of a user.

Various implementations include a method for suctioning liquids from the mouth of a user. The method includes providing a toothbrush comprising bristles and a toothbrush body; providing a dental suction device as described above; and disposing the pair of secondary conduits and the shaft of the suction device on the toothbrush body such that the bristlehead of the toothbrush and the second ends of the pair of secondary conduits face the first direction.

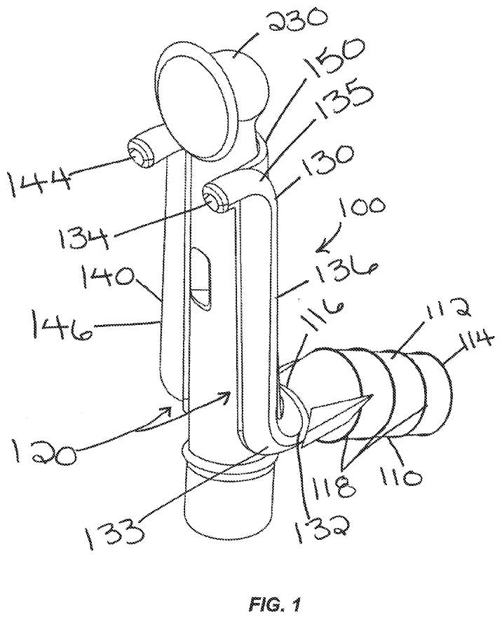

FIG. 1 shows the suction device 100 according to one implementation of the present disclosure. The suction device 100 includes a main conduit 110 (also referred to as the main suction conduit), a pair of secondary conduits 120 (also referred to as suction conduits), and a shaft 150.

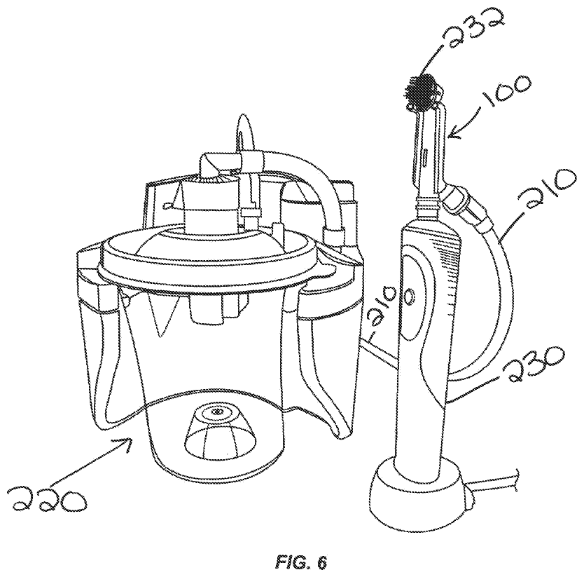

The main conduit 110 includes an outer surface 112, a first end 114, and a second end 116 spaced apart from the first end 114. The outer surface 112 of the main conduit 110 defines a plurality of grooves 118, and the plurality of grooves 118 is sized and configured to engage with a plurality of ridges defined within a suction tube as shown in FIG. 6 and discussed later. In other implementations, the outer surface of the main conduit defines grooves, channels, any other suitable feature, or any combination thereof to facilitate firm attachment of a suction hose or tubing. The first end 114 of the main conduit 110 is tapered, and the second end 116 of the main conduit 110 is fixedly coupled to the pair of secondary conduits 120 such that the main conduit 110 is in fluid communication with the pair of secondary conduits 120. The main conduit 110 includes a first flow path that extends from the first end 114 of the main conduit 110 to the second end 116 of the main conduit 110, and each of the secondary conduits 120 are shaped and configured such that the first flow path is evenly divided between the pair of secondary conduits 120.

In some implementations, the first end of the main conduit includes a diameter of about 1 mm, 2 mm, 3 mm, 4 mm, 5 mm, 6 mm, 7 mm, 8 mm, 9 mm, 10 mm, 11 mm, or 12 mm. In some implementations, the first end of the main conduit includes a diameter in the range of about 6 mm to about 8 mm. In some implementations, the diameter of the first end of the main suction conduit includes a diameter of about 7.5 mm.

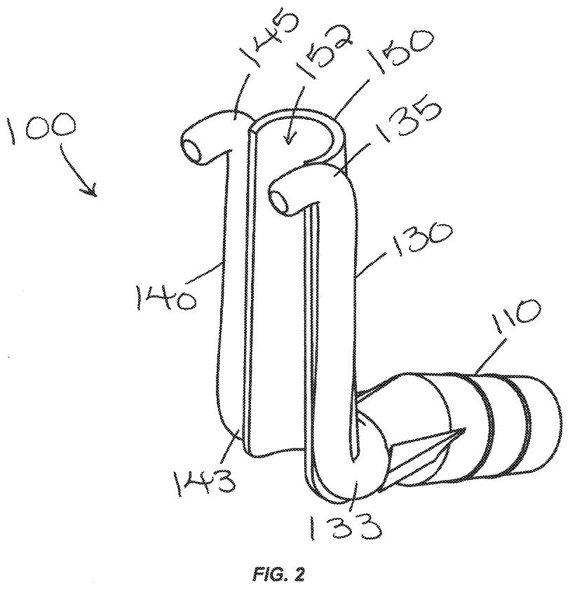

As shown in FIG. 2, the pair of secondary conduits 120 includes a first conduit 130 and a second conduit 140 spaced apart from the first conduit 130. The pair of secondary conduits 120 is configured to apply suction at least subjacent the bristle head of the toothbrush that the suction device 100 is disposed upon. However, in other implementations, the suction device includes a single secondary conduit with at least two openings that are configured to be disposed subjacent the bristles. In other implementations, the suction device includes two, three, or more pairs of secondary conduits. In other implementations, the suction device includes single secondary conduits in addition to a pair of secondary conduits to provide additional suction. The first conduit 130 and the second conduit 140 both include a first end 132, 142 that is fixedly coupled and in fluid communication with the second end 116 of the main conduit 110, and a second end 134,144 that is spaced apart from the respective first end 132, 142. The second end 134, 144 of both the first and second conduits 130, 140 is rounded, smooth, and sized and configured to be disposed within a user's mouth without inflicting pain or discomfort onto the user.

Both the first and second conduits 130, 140 include a first curved portion 133, 143 adjacent their respective first end 132, 142, and a second curved portion 135, 145 adjacent their respective second end 134, 144. The second curved portion 135, 145 of the first and second conduits 130, 140 ensures that the second ends 134, 144 of the first and second conduits 130, 140 are at a downward angle over the lower teeth and adjacent to the floor of the mouth when in use. Both the first and second conduits 130, 140 also include an elongated straight portion 136, 146 between their respective first curved portion 133, 143 and respective second curved portion 135, 145. The elongated straight portion 136, 146 includes a first length, the main conduit 110 includes a second length, and the first length is greater than the second length such that the elongated straight portion 136, 146 is longer than the main conduit 110. The length of the elongated straight portion 136, 146 spaces the second end 134, 144 of both the first and second conduits 130, 140 from the main conduit 110 such that a user does not have to dispose the main conduit within their mouth.

However, in other implementations, the first length is equal to the second length, or the first length is less than the second length for any suitable toothbrush or system combination as long as the second ends of the first and second conduits are substantially spaced from the main conduit. In some implementations the first and second conduits include a diameter of at least 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm or any suitable diameter such that the first and second conduits are comfortably disposable in a user's mouth. In some implementations, the first and second conduits include a diameter in the range of 5 mm to 7 mm. In some implementations, the first and second conduits both include a diameter of 6.2 mm. In some implementations, the first and second conduit have of a length of at least 10 mm, 20 mm, 30 mm, 40 mm, 50 mm, 60 mm, 70 mm, 80 mm, 90 mm or 100 mm. In some implementations, the first and second conduits include a length in the range of about 30 mm to about 50 mm. In some implementations, the first and second conduit include a length of 43.6 mm.

The shaft 150 is disposed between the first and the second conduits 130, 140. The shaft 150 defines a semi cylindrical (or U-shaped) channel 152 that is shaped to receive and retain a portion of the toothbrush in between the pair of secondary conduits 120 as shown in FIGS. 1 and 6. The first and second conduits 130, 140 are disposed opposite each other relative to the shaft 150 and evenly spaced around the shaft 150.

The first and second conduits 130, 140 and the shaft 150 are configured to be removably disposable on a toothbrush having a at least one bristle head. The second ends 134, 144 of the first and second conduits 130, 140 are configured to be located subjacent the bristle head of the toothbrush to suction liquid and debris from user's mouth while a user is brushing their teeth. The suction device 100 is also configured to suction liquids disposed within the mouth of a first user if a second user is brushing the teeth of the first user. Because the first conduit 130, second conduit 140, and shaft 150 are configured to be disposed within a user's mouth, the first conduit 130, second conduit 140, and shaft 150 include a biocompatible material.

In some implementations, the first conduit, second conduit, shaft, and main conduit all include a biocompatible material. In some implementations, the biocompatible material includes materials that are suitable for 3D printing or injection molding. In some implementations the biocompatible material is lightweight and resistant to cracking or breaking. In some implementations, the biocompatible material is Dental SG Resin.

An advantage of the dental suction device 100 as provided herein is the ability of the device to be used with number of commercially available electric toothbrushes. Accordingly, the pair of secondary conduits and the shaft may comprise any size, shape or length. In some embodiments, the size, shape and length of the pair of conduits and the shaft are consistent with that of an electric or manual toothbrush, water flosser, or any dental device that creates liquid waste such as an Oral-B Pro® Electric Toothbrush.

As shown in FIG. 6, the dental suction system 200 includes the dental suction device 100 of FIG. 1, a suction hose 210, an aspirating/vacuum device 220, and a toothbrush 230. The suction hose 210 is removably coupled to the first end 114 and disposed around the outer surface 112 of the main conduit 110 such that the suction hose 210 is in fluid communication with the main conduit 110 and the pair of secondary conduits 120. The aspirating/vacuum device 220 is coupled to the suction hose 210 and provides suction to the suction hose 210, main conduit 110, and pair of secondary conduits 120. The dental suction device 100 is disposed on the toothbrush 230 such that the bristle head 232 of the toothbrush 230, and the second ends 134, 144 of both the first and second conduits 130, 140 face the same direction.

In various implementations, a method for removing liquids from the mouth of a user is disclosed herein. The method includes providing a toothbrush having at least one bristle head and a toothbrush body, providing a dental suction device, and disposing the pair of secondary conduits and the shaft of the suction device on the toothbrush body such that the the pair of secondary conduits are subjacent the bristle head of the toothbrush.

The method further includes providing a suction hose, coupling the suction hose to the first end of the main conduit of the suction device, providing an aspirating/vacuum device, coupling the vacuum device to the suction hose; and turning on the aspirating/vacuum device such that the aspirating/vacuum device creates suction within the suction hose, main conduit, and pair of secondary conduits.

In some implementations, the method further includes brushing the teeth of the user while the aspirating/vacuum device in on such that the liquid within the mouth of the user is suctioned through the second ends of the pair of secondary conduits. In some implementations, the method further includes removing the toothbrush and dental suction device from the mouth of the user. In some implementations, the method even further includes removing the dental suction device from the toothbrush.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A dental suction device configured to be disposed on a toothbrush having at least one bristle head, the device comprising:
a main conduit comprising a first end and a second end spaced apart from the first end;
at least one pair of secondary conduits, each of the secondary conduits comprising a first end and a second end spaced apart from the first end, the first end of each of the secondary conduits connected in fluid communication with the main conduit; and
a shaft coupled to and disposed between the pair of secondary conduits,
wherein the shaft is shaped to receive and retain a portion of the toothbrush in between the pair of secondary conduits such that the pair of secondary conduits is configured to apply suction at least subjacent the bristle head.

2. The dental suction device of claim 1, wherein the second end of the main conduit is fixedly coupled to the first end of each of the secondary conduits.

3. The dental suction device of claim 1, wherein the bristle head faces a first direction and the pair of secondary conduits is configured to be disposed on the toothbrush such that the second ends of each of the secondary conduits also face the first direction.

4. The dental suction device of claim 1, wherein each of the secondary conduits are evenly spaced around the shaft.

5. The dental suction device of claim 1, wherein each of the secondary conduits comprises a first curved portion adjacent the first end of each of the secondary conduits, and wherein each of the secondary conduits further comprises a second curved portion adjacent the second end of each of the secondary conduits.

6. The dental suction device of claim 5, wherein each of the secondary conduits further comprises an elongated straight portion between the first curved portion and the second curved portion, wherein the elongated straight portion has a first length, the main conduit has a second length, and the first length is greater than the second length.

7. The dental suction device of claim 1, wherein the second end of each of secondary conduits is rounded and smooth, and wherein the second end of each of the secondary conduits is sized and configured to be disposed within the first user's mouth.

8. The dental suction device of claim 1, wherein the pair of secondary conduits includes a first conduit and a second conduit spaced apart from the first conduit.

9. The dental suction device of claim 1, wherein the main conduit further comprises an outer surface, the outer surface of the main conduit defines a plurality of grooves, and the plurality of grooves is sized and configured to engage with a plurality of ridges defined within a suction tube.

10. The dental suction device of claim 1, wherein the first end of the main conduit end is tapered.

11. The dental suction device of claim 1, further comprising a suction tube removably coupled to the first end of the main conduit end.

12. The dental suction device of claim 1, wherein the pair of secondary conduits and the shaft comprise a biocompatible material.

13. The dental suction device of claim 1, wherein the main conduit comprises a first flow path extending from the first end of the main conduit to the second end of the main conduit, and wherein the each of the secondary conduits is shaped and configured such that the first flow path is evenly divided between the pair of secondary conduits.

14. The dental suction device of claim 1, wherein the shaft defines a semi cylindrical channel sized and configured to receive a portion of a toothbrush.

15. A dental suction system, the system comprising:
a dental suction device configured to be disposed on a toothbrush having at least one bristle head:
a main conduit comprising a first end and a second end spaced apart from the first end;
at least one pair of secondary conduits, each of the secondary conduits comprising a first end and a second end spaced apart from the first end, the first end of each of the secondary conduits connected in fluid communication with a main conduit; and
a shaft coupled to and disposed between the pair of secondary conduits, wherein the shaft is shaped to receive and retain a portion of the toothbrush in between the pair of secondary conduits such that the pair of secondary conduits is configured to apply suction at least subjacent the bristle head; and
a suction hose removably couplable to the first end of the main conduit, the suction hose configured to provide suction to the main conduit and pair of secondary conduits such that the secondary conduits suction liquids disposed within the mouth of a user.

16. The dental suction system of claim 15, further comprising an aspirating/vacuum device coupled to the suction hose and configured to provide suction to the suction hose, main conduit, and pair of secondary conduits.

17. The dental suction system of claim 15, wherein each of the second ends of the secondary conduits face a first direction, further comprising a toothbrush having at least one bristle head, the toothbrush being disposed within the shaft of the suction device such that the bristle head faces the first direction.

18. A method for suctioning liquids from the mouth of a user, the method comprising:
providing a toothbrush comprising at least one bristle head and a toothbrush body;
providing a suction device, the suction device comprising:
a main conduit comprising a first end and a second end spaced apart from the first end; and
a pair of secondary conduits, each of the secondary conduits comprising a first end and a second end spaced apart from the first end, the first end of each of the secondary conduits being coupled to the main conduit; and
a shaft coupled to and disposed between the pair of secondary conduits, wherein the shaft is shaped to receive and retain a portion of the toothbrush in between the pair of secondary conduits;
disposing the pair of secondary conduits and the shaft of the suction device on the toothbrush body such that the pair of secondary conduits are disposed subjacent the bristle head.

19. The method of claim 18, further comprising providing a suction hose, and
coupling the suction hose to the first end of the main conduit of the suction device;
providing an aspirating/vacuum device, coupling the vacuum device to the suction hose; and
turning on the aspirating/vacuum device such that the aspirating/vacuum device creates negative pressure and suction within the suction hose, main conduit, and pair of secondary conduits.

20. The method of claim 19, further comprising brushing the teeth of the user while the aspirating/vacuum device in on such that the liquid within the mouth of the user is suctioned through the second ends of the pair of secondary conduits.
